(19) United States
(12) Patent Application Publication
(10) Pub. No.: US 2012/0219025 A1
(43) Pub. Date: Aug. 30, 2012

(54) METHOD AND DEVICE FOR ADJUSTING A TUNABLE LASER OF AN OPTICAL NETWORK ELEMENT

(75) Inventors: Erich Gottwald, Holzkirchen (DE); Harald Rohde, Muenchen (DE); Sylvia Smolorz, Mountain View, CA (US)

(73) Assignee: NOKIA SIEMENS NETWORKS OY, ESPOO (FI)

(21) Appl. No.: 13/508,097

(22) PCT Filed: Nov. 4, 2009
(86) PCT No.: PCT/EP2009/064621

§ 371 Date: May 4, 2012

(51) Int. Cl. H01S 3/10

(52) U.S. Cl. 372/20

(57) ABSTRACT

A method and a device are provided for adjusting a tunable laser of an optical network element. A wavelength of the tunable laser is adjusted by varying a current driving the tunable laser. The wavelength of the tunable laser is adjusted by varying a temperature of the tunable laser or at least a portion thereof relative to an environmental temperature.

The invention relates to a method and to a device for adjusting a tunable laser of an optical network element and to a communication system comprising such a device.

A passive optical network (PON) is a promising approach regarding fiber-to-the-home (FTTH), fiber-to-the-business (FTTB) and fiber-to-the-curb (FTTC) scenarios, in particular as it overcomes the economic limitations of traditional point-to-point solutions.

Several PON types have been standardized and are currently being deployed by network service providers worldwide. Conventional PONS distribute downstream traffic from the optical line terminal (OLT) to optical network units (ONUs) in a broadcast manner while the ONUs send upstream data packets multiplexed in time to the OLT. Hence, communication among the ONUs needs to be conveyed through the OLT involving electronic processing such as buffering and/or scheduling, which results in latency and degrades the throughput of the network.

In fiber-optic communications, wavelength-division multiplexing (WDM) is a technology which multiplexes multiple optical carrier signals on a single optical fiber by using different wavelengths (colors) of laser light to carry different signals. This allows for a multiplication in capacity, in addition to enabling bidirectional communications over one strand of fiber.

WDM systems are divided into different wavelength patterns, conventional or coarse and dense WDM. WDM systems provide, e.g., up to 16 channels in the 3rd transmission window (C-band) of silica fibers of around 1550 nm. Dense WDM uses the same transmission window but with denser channel spacing. Channel plans vary, but a typical system may use 40 channels at 100 GHz spacing or 80 channels with 50 GHz spacing. Some technologies are capable of 25 GHz spacing. Amplification options enable the extension of the usable wavelengths to the L-band, more or less doubling these numbers.

Optical access networks, e.g., coherent Ultra-Dense Wave-length Division Multiplex (UDWDM) networks, are deemed to be used as a future data access.

Upstream signals may be combined by using a multiple access protocol, e.g., invariable time division multiple access (TDMA). The OLTs “range” the ONUs in order to provide time slot assignments for upstream communication. Hence, an available data rate is distributed among many subscribers. Therefore, each ONU needs to be capable of processing much higher than average data rates. Such an implementation of an ONU is complex and costly.

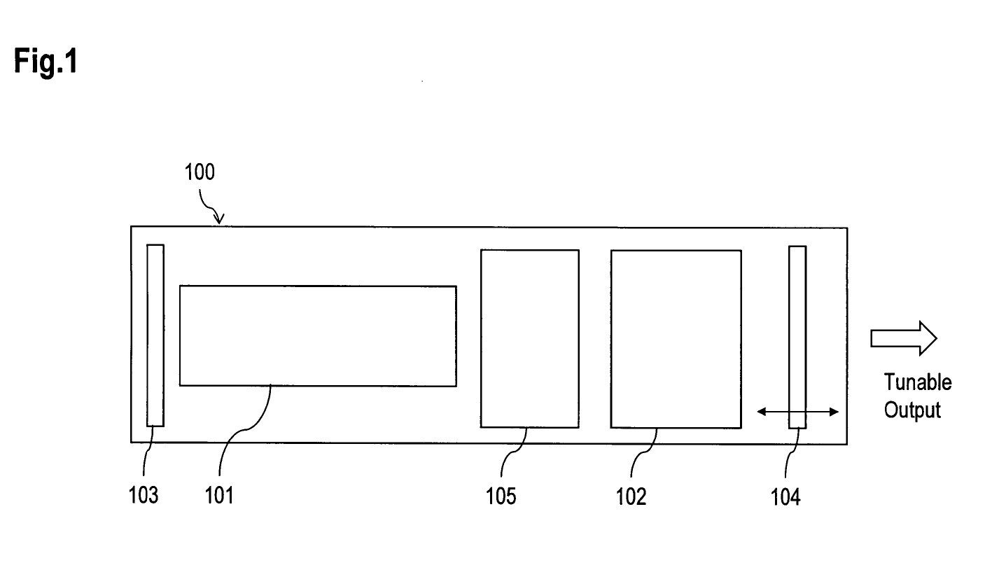

In order to provide a more cost efficient approach, for the purpose of coherent detection, the ONU may be equipped with a less complex and inexpensive local oscillator laser that is tunable over a wide wavelength range, e.g., the C-band (>4 THz scanning range). However, such less complex tunable lasers with external tunable feedback bear the disadvantage of mode-hops when being tuned. FIG. 1 shows a schematic of a generic tunable single-frequency laser 100 comprising a gain element 101, a mode-selection filter 102, a phase shifter 105 and two mirrors 103, 104. The mode-selection filter 102 allows frequency tuning of the laser.

Because of the dense channel spacing in UDWDM systems in the order of a few GHz, the probability of mode-hops while locking on to a channel or tracking a channel is considerably high. Operating the laser at a frequency range close to such mode-hop avoids a stable long term operation and may further result in a phase noise degrading bit error rate.

Tuning such laser by merely using the mode-selection filter 102 results in mode-hops and therefore hops in frequency. This may lead to an interruption of the data stream, which is perceivable to a user.

On the other hand, synchronizing the phase shifter 105 of the single-frequency laser while tuning the mode selection filter 102 would require an exact knowledge of characteristics of the laser regarding a huge number of parameters like, e.g., temperature, spectral position of the filter, laser current, etc. In case one of such parameters is not monitored and/or not controlled accordingly, any synchronized tuning avoiding said mode-hops is not possible.

The problem to be solved is to overcome the disadvantages stated above and in particular to provide a cost-efficient ONU implementation utilizing an inexpensive local oscillator laser allowing for an efficient frequency scanning and/or tracking.

This problem is solved according to the features of the independent claims. Further embodiments result from the depending claims.

In order to overcome this problem, a method for adjusting a tunable laser of an optical network element is provided,
wherein a wavelength of the tunable laser is adjusted by varying a current driving the tunable laser; and
wherein the wavelength of the tunable laser is adjusted by varying a temperature of the tunable laser or at least a portion thereof relative to an environmental temperature.

It is noted that adjusting the wavelength also corresponds to adjusting the frequency of said tunable laser. As frequency and wavelength correspond to each other, each of the terms could be used. In particular, a frequency bandwidth corresponds to a wavelength range.

The temperature is altered relative to the environmental temperature.

Advantageously, the temperature can be altered in discrete steps or portions relative to the environmental (or surrounding) temperature. Preferably, a limited number of steps can be utilized varying the temperature, e.g., 2 to 5 steps.

Temperature variation may be slow compared to the scanning speed feasible by altering the current.

Advantageously, the combination of adjusting the temperature and adjusting the current driving the tunable laser allows adjusting the wavelength seamlessly (at least in sections seamlessly) across a given range.

In an embodiment, the tunable laser is adjusted until it is locked on to a signal.

Such signal may be associated with data and thus constitute a channel that is used for conveying data via the optical network.

In another embodiment, the temperature is adjusted by an amount that substantially corresponds to half the temperature change leading to a mode-hop of the tunable laser.

In a further embodiment, a tunable filter is adjusted to provide substantially step-by-step changes of the wavelength of the tunable laser, in particular associated with mode-hops of the tunable laser.

This tunable filter can be a mechanically driven filter and/or an electronically controlled filter. The tunable filter can be used for mode-hops, i.e. relatively large discrete wavelength adjustments of the tunable laser, wherein the temperature and current adjustments can be used for gradually or continuously adjusting the wavelength of the laser in a predetermined (in particular limited) range. The combination of adjustments referred to herein allows to efficiently traverse a wavelength range, e.g., to scan for and/or track a signal.

In a next embodiment, the following steps are processed unless a signal is detected:
(a) the tunable filter is adjusted for a first mode;
(b) the current is modified to adjust the wavelength across a predetermined wavelength range of the mode;
(c) the tunable filter is adjusted to a subsequent mode and it is branched off to step (b).

Said signal that is not detected may refer to a signal or channel that could not be locked on to. Hence, unless a signal is detected, the current is adjusted to scan the wavelength range associated with such mode, and then the mode is incremented or decremented. If the signal is detected, this loop terminates. In this case, a tracking process may be initiated to lock on to the signal and track the signal, which may drift due to changes of, e.g., the environmental temperature.

Advantageously, this approach enables a fast scanning for a signal somewhere in a wavelength range. Scanning via the tunable filter only would result in skipping significant wavelength intervals; adjusting the current for each mode allows for at least partially covering the intervals that would otherwise be omitted.

It is also an embodiment that the following step is provided between the steps (b) and (c):
(b1) if a limit of a wavelength range is reached, the temperature is adjusted and subsequent modes will be selected towards the opposite direction of the limit of the wavelength range.

For example, an upward scanning may have been conducted increasing the modes selected by the tunable filter until the limit of the wavelength range is reached. A change of temperature results in shifting the modes over the wavelength range. Next, the scanning continues in the opposite direction, i.e. downward, wherein at each mode selected, the current is adjusted to provide coverage for a continuous range of the respective mode. This continuous scanning by adjusting the current of the tunable laser covers a different wavelength range compared to the preceding upward scanning, because of the temperature and thus wavelength shift. Advantageously, the downward scanning covers wavelengths that were not scanned in upward direction and thus may reveal the wavelength of the signal to be locked on to.

It is noted that this approach works accordingly the other way round, i.e. first downward then upward direction. It is further noted that after the end of the wavelength range has been reached, scanning may continue in the opposite direction after a predetermined temperature shift. This may go on (back and forth) as long as an exit condition is not met.

The temperature shift may amount substantially to ΔT_{mode}/2, wherein ΔT_{mode} corresponds to a temperature change that would lead to a mode-hop.

Pursuant to another embodiment, the wavelength adjustments are conducted during a scanning phase for and/or during a tracking phase of a signal.

The tunable filter can be adjusted in particular during the scanning phase. Hence, during the scanning phase, modes of the tunable laser can be selected by the tunable filter, and then a tracking phase can be processed to maintain the lock on the signal in the actual mode.

According to an embodiment, the scanning phase utilizes preceding information to determine whether to scan in upward or in downward direction.

Hence, a history or previous knowledge can be utilized when the scanning phase is entered. For example, a preceding tracking phase would indicate the previous mode and the direction of a tracking phase towards a subsequent mode; hence, the scanning phase may utilize such information to scan towards the correct direction.

According to another embodiment, the wavelength adjustments are conducted during a startup of the optical network element and/or during a mode of operation.

Hence, during an initial startup of the optical network element, a signal can be detected via a scanning phase. In this case, the tunable laser of an ONU may adjust its wavelength to a predetermined wavelength of a channel or signal transmitted by an OLT to this ONU.

During operation of the optical network element, a drift of the wavelength can be determined and compensated utilizing said tracking phase.

In yet another embodiment, the current of the tunable laser is adjusted if the tunable laser operates in single mode.

During the tracking phase, the current driving the tunable laser can be adjusted if the tunable laser is in single mode operation.

According to a next embodiment, the temperature is adjusted if the tunable laser operates in multi mode.

This may be applicable during the tracking phase, in particular to compensate a drift. In the tracking phase, the signal or channel is locked and slow changes (compared to the scanning phase) are to be determined and compensated. One option to compensate such drift is adjusting the current of the tunable laser (if the tunable laser is in single mode, otherwise (i.e. in multi mode) there would be no valid interval for adjusting the current). Another option (if the tunable laser is in multi mode) is adjusting the temperature, i.e. increasing or decreasing the temperature depending on whether a heater is already OFF or ON. Ideally, the drift may be compensated. If not, a mode-hop is required which can be achieved by initiating the scanning phase.

The temperature may be adjusted by utilizing a heater or a heating element that allows changing the temperature of the tunable laser compared to the environmental temperature. It is noted that a temperature may be adjusted in both directions (heating or cooling) depending on the adjustment to be made.

Pursuant to yet an embodiment, the optical network element is an optical network unit or an optical line termination.

The problem mentioned above is also solved by an optical network element comprising
a tunable laser,
a control element to adjust a current driving the tunable laser,
a temperature control to adjust a temperature of the tunable laser or at least a portion thereof relative to an environmental temperature.

According to an embodiment, the optical network element comprises a tunable filter to adjust a mode of the tunable laser.

According to an embodiment, the optical network element comprises a control unit that is arranged such that the method as described herein can be executed.

The problem stated supra is further solved by an optical communication system comprising the one optical network element as described herein.

Embodiments of the invention are shown and illustrated in the following figures:

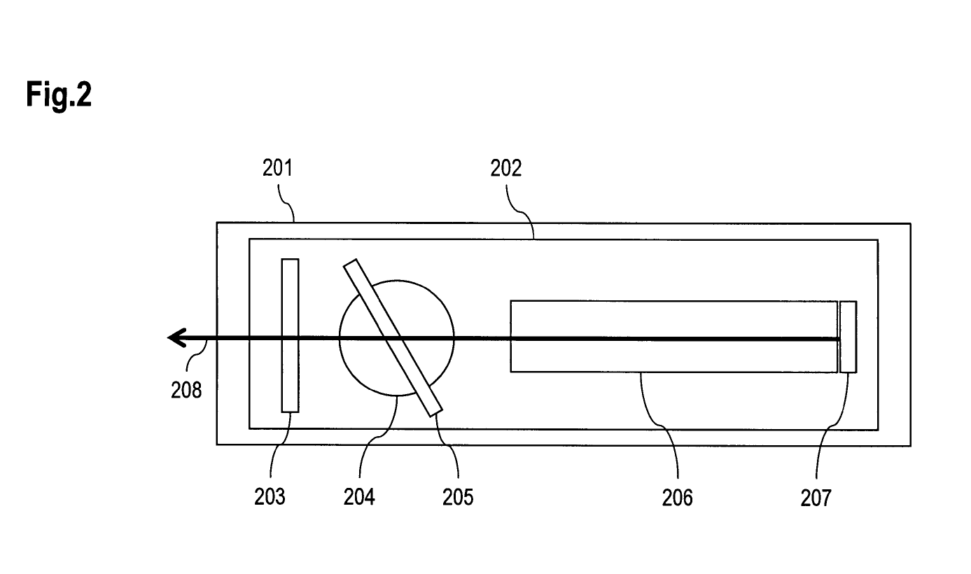

FIG. 2 shows a schematic diagram of a tunable laser that could be deployed, e.g., with an ONU;

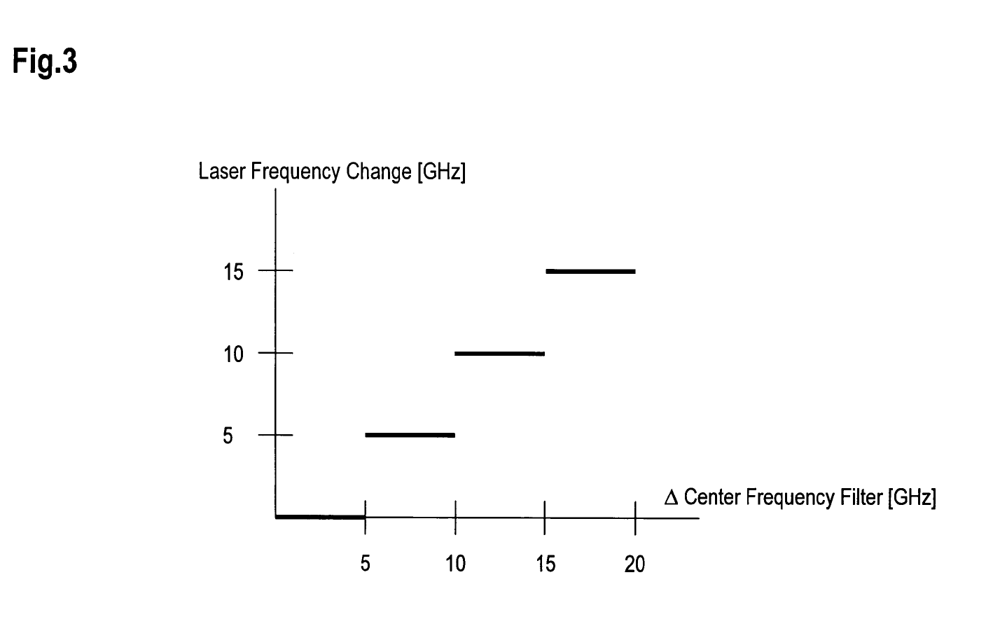

FIG. 3 shows a diagram visualizing several modes of a tunable laser depending upon a change of a frequency of a filter (e.g., the dielectric of FIG. 2);

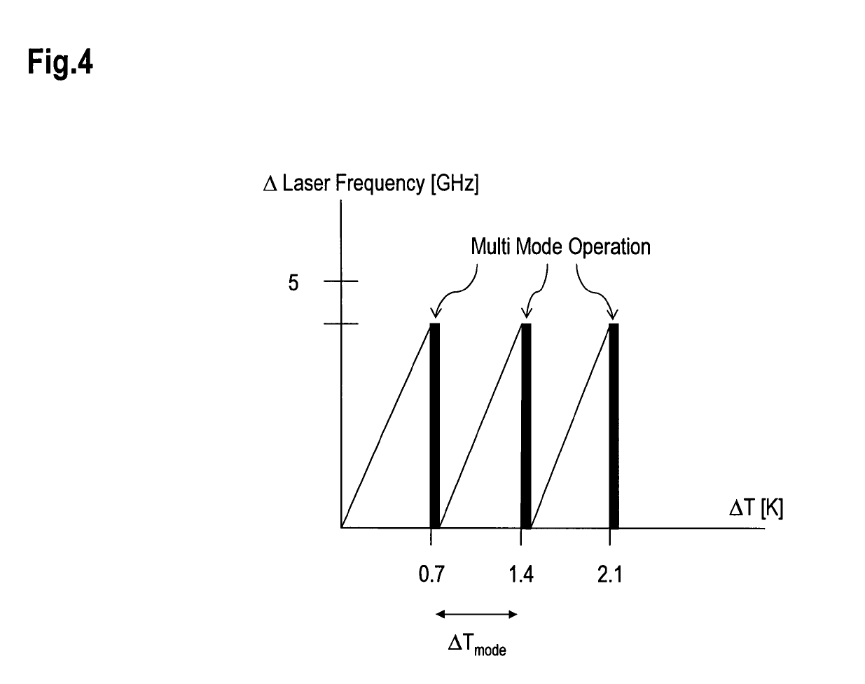

FIG. 4 shows a diagram visualizing the relationship between the change of temperature and the change of the frequency of the tunable laser;

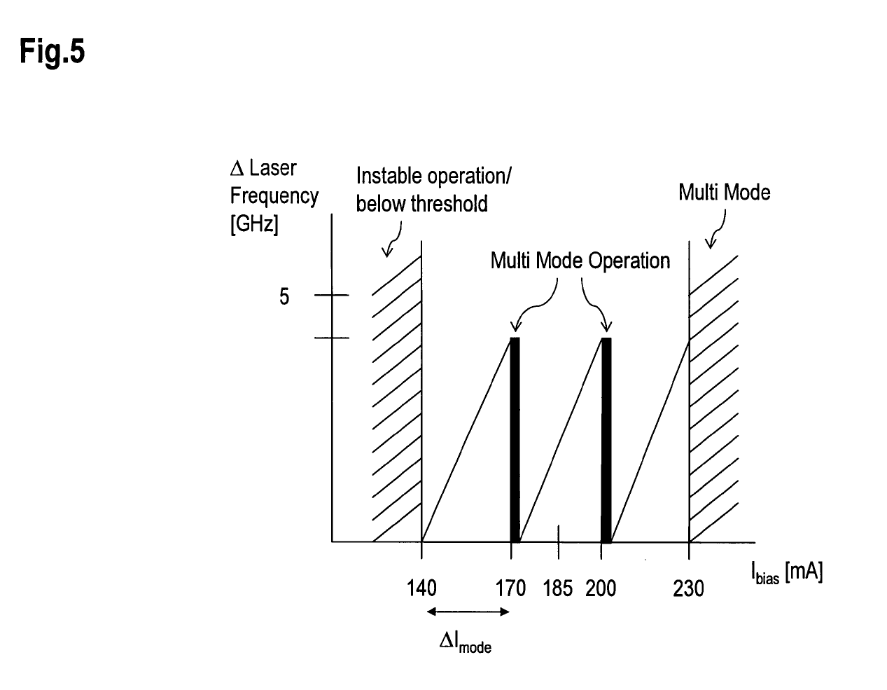

FIG. 5 shows a diagram visualizing the relationship between the change of the bias current and the change of the laser frequency of the tunable laser;

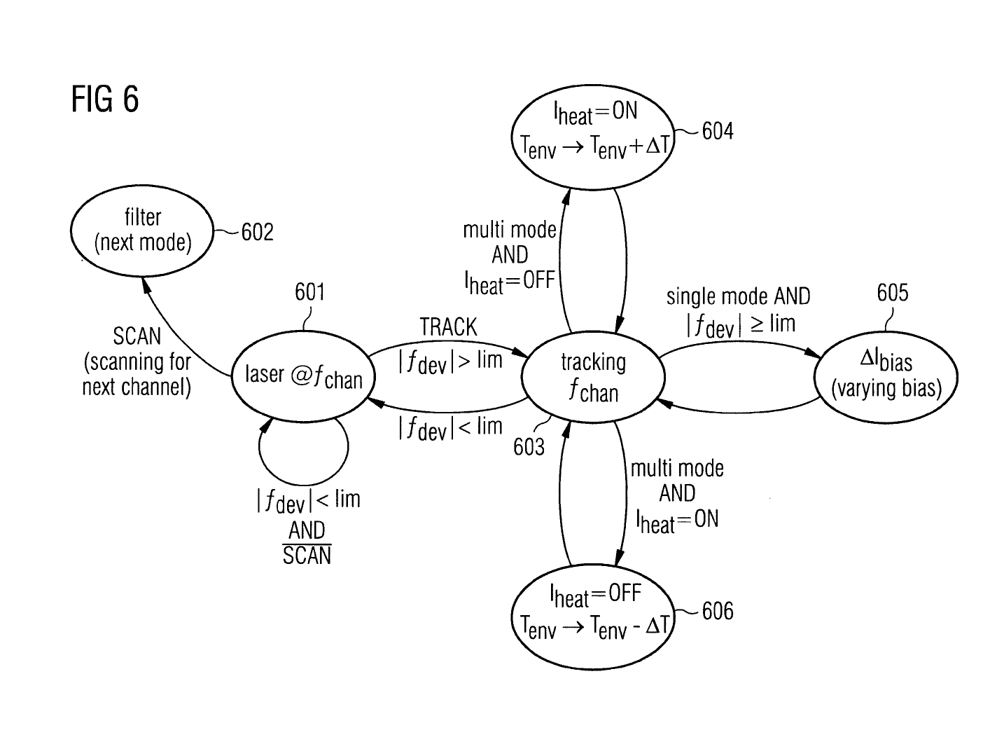

FIG. 6 shows an exemplary schematic state diagram comprising a state machine that can be utilized for tracking a channel;

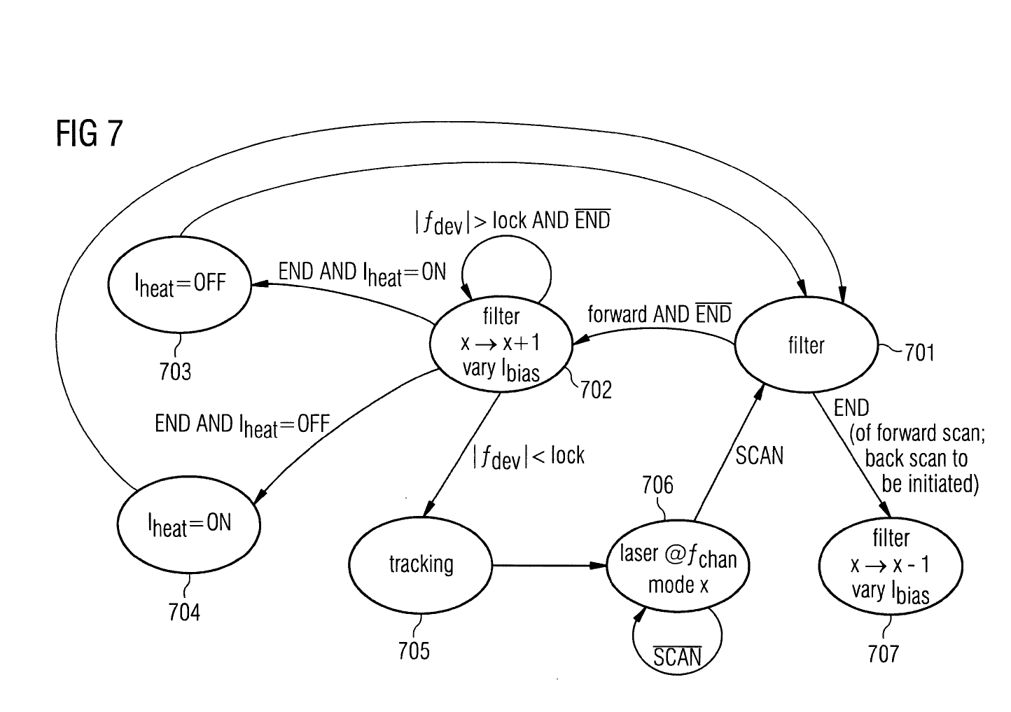

FIG. 7 shows an exemplary schematic state diagram comprising a state machine that can be utilized for scanning for a channel.

The approach presented herein in particular utilizes at least one of the following topics:

(a) Detection of an impending mode-hop on time: A mode-hop is indicated by an increase of the phase noise and/or amplitude noise of the tunable laser and may thus be detected by measuring a bit-error rate or control signal of a Costas loop (e.g., in case of heterodyne detection of DQPSK) or other carrier tracking loops at the receiver site (laser locked to signal while tracking).

(b) A temperature may be changed by a small amount ΔT relative to an environmental temperature. This temperature amount ΔT is typically a temperature change necessary for tuning the frequency over substantially half the mode spacing without any additional measures.

(c) A forthcoming mode-hop can be predicted by evaluating a frequency control parameter history.

(d) No special control for a cavity phase alignment in accordance with a filter position is required.

FIG. 2 shows a schematic diagram of a tunable laser that could be deployed, e.g., with an ONU. The tunable laser comprises an active medium 206 that is attached to a mirror 207. A dielectric filter 205 is located on a micro motor 204 and can be adjusted by being rotated. In addition, a semitransparent mirror 203 is provided. The laser beam 208 is conveyed via the active medium 206, the dielectric filter 205 and the semitransparent mirror 203. The components are arranged on a motherboard 202 that is coupled with a low power heater 201.

The tunable laser of FIG. 2 can be adjusted as follows:

(1) Tuning of (only) the filter may result in stepwise frequency changes of the frequency of the tunable laser with mode-hops amounting to Of each (step sizes of a compact resonator design may be in the order of 1 GHz to 10 GHz). This is visualized in FIG. 3, showing several modes of a tunable laser depending upon a change of a frequency of a filter (e.g., the dielectric filter 205 of FIG. 2).

(2) A temperature of the motherboard 202 can be adjusted, which results in continuously tuning the frequency up to

α_{T}·Δf with α_{T}<1,

as a result of expansion coefficients as well as of the arrangement of the assembly. After a temperature change amounting to ΔT_{mode} the tunable laser enters a multi mode operation (leading to a mode-hop), then—further changing the temperature—the tunable laser starts again close to the initial value and so on. FIG. 4 shows a diagram visualizing the relationship between the change of temperature and the change of the frequency of the tunable laser.

(3) A bias current I_{bias} of the active medium (e.g., the gain element and/or an SOA) can be adjusted, which leads to continuously tuning the frequency up to

α_{c}·Δf with α_{c}<1 and α_{c}≈α_{T}.

At a bias current change of about ΔI_{mode}, the tunable laser enters multi mode operation (leading to a mode-hop); then, in case the bias current is further changed (e.g., increased), the tunable laser's frequency change starts again close to its initial value.

In contrast to the case (2) above, the number of periods is limited by the fact that changing the current I_{bias} evokes two effects: The temperature of the active medium and therefore its optical length changes as well as the gain and output power varies.

FIG. 5 shows a diagram visualizing the relationship between the change of the bias current and the change of the laser frequency of the tunable laser. Outside an exemplary interval ranging from 140 mA and 230 mA of the bias current, below the bias current of 140 mA is an instable mode of operation and above 230 mA is a region of multi mode operation.

It is noted that the transmission of the mode selecting filter is predominantly not affected by temperature variations.

It is also noted that time required for thermal adjustments may be in the range of 1 to 0.1 seconds and is at least two orders of magnitude larger than the time required for electrical tuning (e.g., in the range of 10⁻⁴ to 10⁻⁵ seconds).

The following shows exemplary data that may be applicable for the tunable laser as shown in FIG. 2:
Mode spacing Δf: 5 GHz;
Tuning factor α_{c}≈α_{T}=0.75;
ΔT_{mode}=0.7 K;
ΔI_{mode}=30 mA (current bias I₀=185 mA, operation from 170 to 200 mA).

This data set indicates that it may be difficult or impossible to adjust the tunable laser with the resonator design as shown in FIG. 2 to any arbitrary wavelength without matching the temperature of the resonator. Because of an imperfect anti-reflection coating of the gain element (active medium 206 in FIG. 2) there are in fact two coupled resonators, which need to be synchronized for continuous seamless tuning purposes. This can be achieved by an absolute temperature control utilizing, e.g., a Peltier element and/or a heater in combination with a temperature sensing unit and a phase matching detection unit. The disadvantage of such an approach, however, is a high amount of power consumption of at least 1 W.

Hence, the approach suggested here in particular adjusts the temperature while retaining the other parameters; then, a periodical behavior as a function of the temperature can be utilized as shown in FIG. 4 and an electrical tuning (see FIG. 5) can be conducted, which requires only a short amount of time (e.g., less than 10⁻⁴ seconds) for re-adjusting the wavelength of the tunable laser compared to the time (e.g., 1 ms) required for the temperature to adjust.

Accordingly, the temperature of the resonator assembly of the tunable laser can be changed by a heater by ΔT_{mode}/2 or ΔT_{mode} (see FIG. 4) compared to an environmental temperature Tₑₙᵥᵢᵣₒₙₘₑₙₜ. The small amount of temperature adjustment advantageously corresponds to a low power consumption. Hence, preferable temperatures are:

T=Tₑₙᵥᵢᵣₒₙₘₑₙₜ or

T=Tₑₙᵥᵢᵣₒₙₘₑₙₜ+ΔT_{mode}/2 or

T=Tₑₙᵥᵢᵣₒₙₘₑₙₜ+ΔT_{mode}.

With regard to the solution presented herein (e.g., scanning, tracking and/or compensating of a drift of the temperature Tₑₙᵥᵢᵣₒₙₘₑₙₜ) increasing the temperature or the laser current may decrease the laser frequency. A timescale of a state “scanning” may be in the order of seconds, a timescale of a state “tracking”, comprising in particular a “laser frequency re-adjustment” after a mode hop, may last significantly longer, e.g., hours or days.

Tracking of a Channel

FIG. 6 shows an exemplary state diagram comprising a state machine that can be utilized for tracking a channel.

In a state 601 the tunable laser is adjusted to a frequency of a channel f_{chan}. In case a frequency deviation f_{dev} from a target value is below a predefined threshold (|f_{dev}|<lim, wherein lim indicates a predetermined value allowed for f_{dev}) and in case no scanning ( S̅C̅A̅N̅, i.e. the channel is locked, in particular wherein f_{dev} is below a locking range) is conducted, the state 601 is retained.

Otherwise, in case the frequency deviation from the target value exceeds the predefined threshold (|f_{dev}|>lim), tracking is conducted and the state 601 switches to a state 603.

It is noted that the case |f_{dev}|=lim may be allocated to one of the both conditions (below threshold or exceeding the threshold) depending on the actual implementation. In the functional explanation provided herein, the case “equals the threshold” may not be explicitly mentioned, but could be covered by either of both variants. This concept applies to upcoming comparisons in an analogue manner.

In case no multi mode is reached (i.e. the tunable laser being in the single mode) and in case the frequency deviation from the target value reaches or exceeds the predefined threshold (|f_{dev}|≧lim, the state 603 switches to a state 605, wherein a bias current I_{bias} can be modified in order to adjust the tunable laser's wavelength. This corresponds to the scenario shown in FIG. 5. If multi mode is detected or if the frequency deviation from the target value is below the predefined threshold (|f_{dev}|<lim), the state 605 reverts to the state 603.

On the other hand, if in state 603 multi mode is detected and the heater is in an ON state (detectable via the current Iₕₑₐₜ supplied to the heater), the state 603 switches to a state 606, wherein the heater is switched OFF and an environmental temperature Tₑₙᵥ is reduced by an amount ΔT. Then, the state 606 reverts to the state 603.

If in state 603 multi mode is detected and the heater is in an OFF state (detectable via the current Iₕₑₐₜ), the state 603 switches to a state 604, wherein the heater is switched ON and an environmental temperature Tₑₙᵥ is increased by an amount ΔT. Then, the state 604 reverts to the state 603.

If in state 603 the frequency deviation from the target value is below the predefined threshold (|f_{dev}|<lim), the state 603 reverts to the state 601 and tracking is concluded.

If in state 601 scanning is to be conducted for a next channel, the state 601 switches to a state 602, wherein a filter is adjusted (e.g., set to a subsequent mode). This scanning process is also described hereinafter with regard to FIG. 7.

Channel tracking is beneficial in order to keep an intermediate frequency IF constant while the OLT is drifting or because of a drifting of an environmental temperature. A frequency control unit of the tunable laser may recognize an impending mode-hop of the tunable laser, e.g., via a control parameter such as the current driving the active medium.

If this is caused by an environmental temperature change, depending on the status of the heater, the heating current is either switched ON or OFF (see states 604 and 606) and the fast frequency control keeps the lock on the intermediate frequency IF by adjusting the bias current.

The filter keeps its position as the wavelength of the incoming channel still fits to the filter which is not affected by environmental temperature variations.

If the frequency of the incoming channel drifts and the ONU frequency control by current reaches the limit, a new filter setting is required (transition to the state 602); in this case, a mode-hop cannot be avoided.

Adjusting the filter, a direction information, i.e. one frequency step up or down, may be derived from a control history. Based on preceding information, the direction of the drift (up or down) in the frequency domain could be determined. Depending on the heater's status, the filter may be adjusted (see also FIG. 7), the heating current may be switched ON or OFF and the fast frequency control via the bias current can adjust the wavelength of the tunable laser to detect the channel within the current tuning range.

Scanning for a Channel

FIG. 7 shows an exemplary state diagram comprising a state machine that can be utilized for scanning for a channel.

A filter is in a predefined setting according to a state 701. In case forward scanning is to be conducted and in case the end of the scanning range has not been reached (END), the state 701 switches to a state 702, wherein the filter is adjusted to a subsequent mode x+1. Then, the current I_{bias} of the tunable laser is modified across a given range (as, e.g., shown in FIG. 5) to scan between the modes that are selectable by the tunable filter.

In case the frequency deviation from the target value exceeds a predefined locking range (|f_{dev}|>lock) and the limit of the scanning range has not been reached (END), this state 702 is retained, i.e. no signal or channel to lock on to has been found yet.

If the limit of the scanning range is reached and if the heater is in an ON state (detectable via the current Iₕₑₐₜ supplied to the heater), the state 702 switches to a state 703, wherein the heater is switched OFF. The temperature is adjusted (decreased by, e.g., ΔT_{mode}/2) to a certain extent in view of the environmental temperature. Then, the state 703 switches to the state 701.

If the limit of the scanning range is reached and if the heater is in an OFF state (detectable via the current Iₕₑₐₜ supplied to the heater), the state 702 switches to a state 704, wherein the heater is switched ON. The temperature is adjusted (increased by, e.g., ΔT_{mode}/2) to a certain extent in view of the environmental temperature. Then, the state 704 switches to the state 701.

If, however, the frequency deviation from the target value is below the predefined locking range (|f_{dev}|<lock), the state 702 switches over to a state 705, wherein a tracking as shown in FIG. 6 is conducted. This corresponds to the scenario when a signal has been detected and there is a lock on to a channel. Then, the scanning may migrate into tracking.

As a result of such tracking a state 706 is reached, wherein the laser is adjusted to a channel frequency at the mode x. This state 706 is retained as long as the tunable laser is locked to the channel (SCAN). In case there is no longer a lock to the channel, scanning (SCAN) is to be conducted and the state 706 switches to the state 701.

If the end of the forward scan is reached, a scan in the reverse direction is initiated. Hence the state 701 switches to a state 707 and the filter is set to a previous mode x-1. Then, the current I_{bias} of the tunable laser is modified across a given range (as, e.g., shown in FIG. 5) to scan between the modes that are selectable by the tunable filter. From the state 707 scanning for a channel is conducted accordingly as described with regard to the forward direction scenario (i.e. similar to the state 702).

The scanning procedure should be performed swiftly in order to reduce the time required until a channel is found and locked on to. Adjusting the tunable laser only via its current is considerably fast, but does not cover gaps between resonator modes. Hence, there are gaps in such a wavelength scan (modifying only the tunable filter to select a mode and adjusting the current for a partial scan between the respective modes). The coverage is about (1-α) and therefore, with a probability of about (1-α) the desired channel is not found, e.g., lies within the gap that is not scanned. It is noted that a may exceed 50%.

At the end of the (forward) scan (or tuning range), the temperature is increased by, e.g., ΔT_{mode}/2 and a scan in reverse direction is initiated, i.e. the same procedure runs towards the opposite end of the tuning range.

Advantageously, this approach does not require a temperature control, because a predetermined amount of energy utilized leads to a deterministic temperature increase with regard to the environment. As the scanning is very fast (e.g., requiring a time period less than 1 second), the environmental temperature can be assumed as being approximately constant during such scanning procedure.

### LIST OF ABBREVIATIONS

CWDM Coarse WDM

LO (optical) Local Oscillator

OLT Optical Line Terminal

ONT Optical Network Termination

ONU Optical Network Unit

PD Photo Diode

PM Phase Modulation unit

PON Passive Optical Network

SOA Semiconductor Optical Amplifier

UDWDM Ultra Dense WDM

WDM Wavelength Division Multiplex

1-15. (canceled)

16. A method for adjusting a tunable laser of an optical network element, which comprises the steps of:
adjusting a wavelength of the tunable laser by varying a current driving the tunable laser; and
adjusting the wavelength of the tunable laser by varying a temperature of the tunable laser or at least a portion of the tunable laser relative to an environmental temperature.

17. The method according to claim 16, which further comprises adjusting the tunable laser until the tunable laser is locked on to a signal.

18. The method according to claim 16, which further comprises adjusting the temperature by an amount that substantially corresponds to half a temperature change leading to a mode-hop of the tunable laser.

19. The method according to claim 16, which further comprises adjusting a tunable filter to provide substantially step-by-step changes of the wavelength of the tunable laser.

20. The method according to claim 19, which further comprises processing the following steps unless a signal is detected:
a) adjusting the tunable filter for a first mode;
b) modifying the current to adjust the wavelength across a predetermined wavelength range of a mode; and
c) adjusting the tunable filter to a subsequent mode and branching back to step b).

21. The method according to claim 20, which further comprises performing the following step between the steps b) and c):
adjusting the temperature and the subsequent modes will be selected towards an opposite direction of a limit of the wavelength range, if the limit of the wavelength range is reached.

22. The method according to claim 16, which further comprises conducting wavelength adjustments during at least one of a scanning phase for a signal or a tracking phase of the signal.

23. The method according to claim 22, wherein the scanning phase utilizes preceding information to determine whether to scan in an upward direction or in a downward direction.

24. The method according to claim 16, which further comprises conducting wavelength adjustments during a startup of at least one of an optical network element or a mode of operation.

25. The method according to claim 16, which further comprises adjusting the current of the tunable laser if the tunable laser operates in a single mode.

26. The method according to claim 16, which further comprises adjusting the temperature if the tunable laser operates in a multi mode.

27. The method according to claim 16, which further comprises selecting the optical network element from the group consisting of an optical network unit and an optical line termination.

28. The method according to claim 19, wherein the wavelength of the tunable laser is associated with mode-hops of the tunable laser.

29. An optical network element, comprising:
a tunable laser;
a control element for adjusting a current driving said tunable laser; and
a temperature controller for adjusting a temperature of said tunable laser or at least a portion of said tunable laser relative to an environmental temperature.

30. The optical network element according to claim 29, further comprising a tunable filter to adjust a mode of said tunable laser.

31. An optical network element, comprising:
a control unit programmed to:
adjust a wavelength of a tunable laser by varying a current driving the tunable laser; and
adjust the wavelength of the tunable laser by varying a temperature of the tunable laser or at least a portion of the tunable laser relative to an environmental temperature.
